(19) United States
(12) Patent Application Publication
(10) Pub. No.: US 2005/0244556 A1
(43) Pub. Date: Nov. 3, 2005

(54) Electrolyzed water treatment for meat and hide

(76) Inventor: Gaylord Karren, Lindon, UT (US)

Correspondence Address: James E. Bradley;Bracewell & Patterson, L.L.P., P.O. Boz 61389, Houston, TX, 77208-1389, US

(21) Appl. No.: 11/118,011

(22) Filed: Apr. 29, 2005

Related U.S. Application Data
(60) Provisional application No. 60/566,243, filed on Apr. 29, 2004.

(51) Int. Cl. A23B 4/14

(52) U.S. Cl. 426/335; 205/701

(57) ABSTRACT

The present invention relates to a method for cleaning and disinfecting. A food product is provided, as well as a first non-toxic solution including an electrolyzed alkaline solution and a second non-toxic solution including an electrolyzed acidic solution. The food product is cleaned by saponifying the first solution to a surface of the food product. The food product is then disinfected by applying the second solution to the surface of the food product. The present invention also relates to an additional method for cleaning and disinfecting. A hide is removed from a carcass of an animal. The hide is cleaned by saponifying the hide with a first non-toxic solution including an electrolyzed alkaline solution. The hide is then disinfected by applying to the hide a second non-toxic solution containing an electrolyzed acidic solution.

### RELATED APPLICATIONS

This application claims the benefit under § 119(e) of U.S. Provisional Application Ser. No. 60/566,243, filed Apr. 29, 2004 which is incorporated herein by reference.

### FIELD OF THE INVENTION

This invention relates in general to cleaning and disinfecting. More particularly, this invention relates to an apparatus and method for cleaning and disinfecting meat and hide products by using electrolyzed water.

### BACKGROUND OF THE INVENTION

The Center for Disease Control (CDC) estimates 76 million cases of meat-borne illnesses each year. Most cases are related to surface or product contamination caused by traditional toxic chemicals. Up to one-third of the illnesses are related to improperly handled meat and produce. Additionally, an estimated 5200 people in the United States die each year from meat poisoning. Pathogens are building resistance to many products and methodologies now used to control the problem, products that are often toxic and environmentally harmful. On average, every hour approximately 4000 gallons of toxic, chlorine gas-activated water pour onto carcasses in the United States. In the past, an extremely toxic trisodium phosphate or acidified sodium chlorite have been commonly used to disinfect the carcasses. Toxic trisodium phosphate or acidified sodium chlorite cannot be used at high enough concentrations to effectively kill the most problematic organisms. A serious need exists throughout the meat processing industry for effective cleaning and disinfecting alternatives.

Electrolysis is a process for producing electrolyzed oxidizing (EO) water wherein feed water solution including a saline solution component is supplied to an electrolytic cell comprising both an anode chamber and a cathode chamber. When normal culinary tap water is combined with an electrolyte (i.e., salt) and placed in contact with an electrical probe or plate coated with platinum, electrolysis occurs once the probe or plate is electrically charged by a power source. These coated probes or plates are separated by a Teflon® membrane, which helps to isolate and separate certain chemical ions. During the chemical reaction, negatively charged ions naturally migrate towards the positive electrode (i.e., anode) and positively charged ions including hypochlorous acid (HOCl) naturally migrate to the negative electrode (i.e., cathode). The feed water solution is cathodically electrolyzed in the cathode chamber to produce EO water as an antioxidant solution called alkaline catholyte. The feed water solution is anodically electrolyzed in the anode chamber to produce EO water as an oxidant solution called anolyte, whose pH is modified in the process. Anolyte is a strong oxidizing solution.

More specifically, the acidic electrolyzed water is normally generated from the anode electrode through electrolysis of a dilute aqueous NaCl solution. The Cl⁻¹ ions are electrochemically oxidized to Cl₂ gas on the anode surface, which gas is partially hydrolyzed to hypochlorous acid (HOCl) in solution phase and to other ions. The relatively high batericidal activity of the acidic EO water is attributed to so-called active chlorine which comprises dissolved Cl₂, OCl⁻, and HOCl, and is also attributed to the high oxidation-reduction potential (ORP) of the acidic EO water.

### SUMMARY

The present invention relates to a method for cleaning and disinfecting. A food product is provided, as well as a first non-toxic solution including an electrolyzed alkaline solution and a second non-toxic solution including an electrolyzed acidic solution. The food product is cleaned by saponifying the first solution to a surface of the food product. The food product is then disinfected by applying the second solution to the surface of the food product.

The present invention also relates to an additional method for cleaning and disinfecting. A hide is removed from a carcass of an animal. The hide is cleaned by saponifying the hide with a first non-toxic solution including an electrolyzed alkaline solution. The hide is then disinfected by applying to the hide a second non-toxic solution containing an electrolyzed acidic solution.

### BRIEF DESCRIPTION OF THE DRAWINGS

FIG. 1 is a flow chart diagram in accordance with an embodiment of the method of the invention.

FIG. 2 is a flow chart diagram in accordance with another embodiment of the method of the invention.

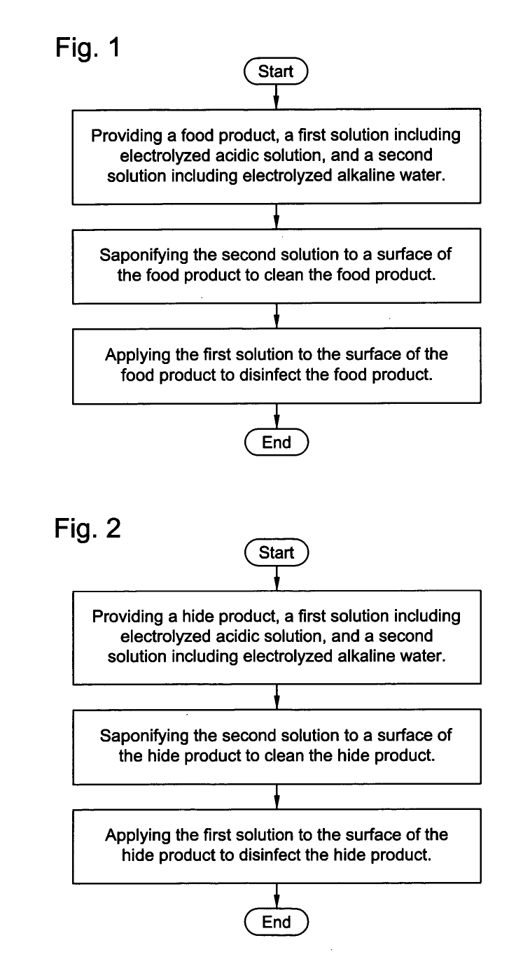

### DETAILED DESCRIPTION OF THE INVENTION

Although the following detailed description contains many specific details for purposes of illustration, anyone of ordinary skill in the art will appreciate that many variations and alterations to the following details are within the scope of the invention. Accordingly, the exemplary embodiment of the invention described below is set forth without any loss of generality to, and without imposing limitations thereon, the claimed invention.

Electrolyzed water produced by electrolysis is classified herein into three types: acidic electrolyzed water, alkaline ionized water, and alkaline electrolyzed water. The present invention uses electrolyzed water, referred to herein as Type A solution and Type B solution, and Type C solution, to reduce pathogenic microorganisms on meat or hide, and thereby clean and disinfect the meat or hide. In addition to the Type A, B, and C solutions, additional materials utilized in the solution generating process include a soft water supply, a saline solution, electricity, and cell materials. Generators employ electrolysis to produce high volumes of electrolyzed oxidative water. The generators use a unique combination of cell technology, salt, and electricity to alter the molecular structure of water to provide for increased sanitizing characteristics.

Type A solution is a disinfecting fluid that kills a large variety of bacteria, viruses, molds, and spores, within seconds of contact. Type A solution is capable of replacing chlorinated water, and is more effective at killing pathogens without the toxicity. Plus, the microbicidal capabilities of Type A are dramatically higher than chlorinated water. When the positively charged ions migrate to the cathode, the fluid around the cathode, also known as electrolyzed Type A solution, develops a reduced pH valuing from 7 for neutral tap water to an approximate range of 1.8 to 2.4 for acidic Type A solution. Another chemical change that occurs around the cathode is that the oxidative/reduction potential (ORP) of water increases dramatically. The conductivity measures the capacity of a fluid to oxidize or break down the double bonding of an organism cell wall. Normal tap water is naturally conductive and has an ORP reading of about 700 mV.

The acidic Type A solution around the cathode has an increased ORP reading or conductivity in the approximate range of about 1100⁺ mV 1170⁺ mV. Thus electrolyzed Type A solution is produced on a continuous flow basis as a clear, innocuous solution having a pH of 1.8-2.4, ORP of 1,000-1,170⁺ mV and containing 10-200 ppm of HOCl. HOCl is a powerful oxidizing agent, which is much more effective as an antimicrobial agent than free chlorine. Such high level of HOCl provides premium condition for disinfecting, yet is still non-toxic to humans. Once the electrolyzed Type A solution comes in contact with an organic agent, pH value increases to 7, ORP reading drops back down to 700 mV and HOCl dissipates or gases off and the fluid returns to water with a microscopic amount of free chlorine (Cl). Safety and toxicity tests showed no toxicity or lysis with Type A solution having HOCl ranging from 10 to 70 ppm, a pH of 2.2 and an ORP reading ranging from 1135⁺ to 1160⁺ mV.

Type B is an extremely effective emulsifier and cleaning fluid with anti-microbial properties, and is capable of saponifying upon contacting the treatment surface. Type B solution is an alkaline water stream, which is a clear innocuous solution simultaneously produced around the positive electrode, i.e., anode, during electrolysis. Alkaline Type B solution is basic and its pH value ranges from 10.5 to 12.0. The oxidative/reduction potential (ORP) of Type B solution has a reading in the range of 800⁻ mV to 1000⁻ mV. Alkaline B also contains sodium hydroxide ions which migrate to the anode during electrolysis. The amount of sodium hydroxide ions may be 10-200 ppm. This ion molecularly has the ability to saponify, or create a microscopic “soap” film on the surface of a target. Type B solution is effective in emulsifying oils and lipids and leaves no residual afterwards. Safety and toxicity tests showed no toxicity or lysis with Type B solution having a pH value ranging from 10.5 to 12.0 and an ORP reading ranging from 800⁻ to 1000⁻ mV.

Type C is a stabilized acidic water used in consumer products as a high-level disinfectant, and also has the capacity to extend shelf life in the products in which it is utilized. Electrolyzed Type C solution is essentially a form of stabilized Type A solution with a longer shelf life, because Type A solution degrades faster than Type C solution. Type C solution has ORP of 850⁺ mV-1150⁺ mV and a pH value of 2.5-6.0, and contains HOCl at a level in the range of 10-200 ppm.

As applied in the present invention and in the following examples, the Type A, Type B, and Type C solutions are utilized to clean and disinfect a meat or meat product. Pathogens which may be on the surface when the tissue is hot, which could be more easily removed for example at a de-hiding station for meat carcasses, can get encapsulated in small crevasses on the texture of the fat surface as the fat cools and hardens. Once this occurs, no disinfecting or intervention steps can get to these enclosed pathogens. Pathogens may end up in the grinding process and contaminate otherwise good products. The Type A, Type B, and Type C solutions are applied to the meat product by spraying or dipping, and effectively clean and disinfect the meat or meat from pathogens or other bacteria, as demonstrated by the following examples.

The present invention and the following examples are also directed to a process of cleaning and disinfecting a hide product. More specifically, it is routine practice for the hide to be removed from the carcass of an animal. The hide is removed from the carcass for purposes of utilizing the hide as a type of leather or other useful material. Therefore, in the same manner as the meat is cleaned and disinfected immediately following de-hiding, similarly the hide that is removed from the hide is also cleaned and disinfected at the de-hiding station immediately following de-hiding. The Type A, Type B, and Type C solutions are applied to the hide product by spraying or dipping, and effectively clean and disinfect the hide from pathogens or other bacteria, as demonstrated by the following examples.

During the entire procedure, as applied to the meat product or hide product, pathogen counts were measured after each step of washing and compared among various cleaning processes. Greater reduction of pathogen counts was observed in the present cleaning and disinfecting procedures compared to other processes (See Examples 1-4).

In the Examples, CFU/cm² means colony forming unit (CFU)/centimeters squared (cm²). A colony forming unit is one pathogenic or bacterial unit or cell. The title is thus given because one pathogenic or bacterial unit or cell is capable of reproducing and forming a visible colony of pathogens or bacteria. The importance of the colony forming unit is to visibly enumerate the number of colonies in any given sample.

### EXAMPLE 1

Reduction of E. coli 015:H7 on cold-stored
meat fat from Sunland meat

| | Reduction |
|---|---|
| Treatment | (Log₁₀ CFU/cm²) |
| 25° C. Deionized water dip | 0.47 |
| 25° C. Acidic EO water (Type A solution) dip | 0.71 |
| 25° C. Alkaline EO water (Type B solution) dip | 0.52 |
| 25° C. Alkaline EG water dip followed by acidic EO | 0.74 |
| water dip (B + Type A solution) | |

The parameters for Example 1 are as follows. The initial population for the test was 4.76 Log ₁₀CFU/cm². EO water was produced using an EO water generator from Electric Aquagenics Unlimited (EAU) at 3.6 A setting. The acidic EO water utilized contained 73 mg/L chlorine. The dip treatment was conducted by immersing individual slices of meat fat tissue (2-4 inches) in 200 ml of treatment solution for 60 seconds with gentle hand shaking. One series of results is shown by the resulting Reduction (Log 10 CFU/cm2) that is apparent from the table. In the Examples, an increase in the value for the Reduction (Log 10 CFU/cm2) means an increase in the amount of pathogens or other bacteria that is reduced or eliminated from the sample due to treatment by the various solutions.

### EXAMPLE 2

Reduction of E. coli 0157:H7 on warm fat during
transportation but reduced to room temperature
during inoculation, holding, and treatment

| | Reduction |
|---|---|
| Treatment | (Log₁₀ CFU/cm²) |
| 24° C. Deionized water dip | 0.32 |
| 24° C. EO water dip | 0.79 |
| 58° C. EO water dip | 1.03 |
| 24° C. Deionized water spray | 1.50 |
| 24° C. EO water spray | 2.38 |
| 58° C. EO water spray | 2.18 |

The parameters for Example 2 are as follows. The initial population was 6.07 Log ₁₀CFU/cm². The acidic EO water utilized contained 77 mg/L chlorine. The dip treatment was conducted by immersing individual slices of meat fat tissue (6 inches diameter circular share) in 200 ml of treatment solution for 60 seconds with gentle hand shaking. The spray treatment was conducted by spraying treatment solution at 80 psi for 60 seconds with a distance of 8.5 cm. The total amount of treatment solution applied was 1300 ml. The results shown by the Reduction (Log 10 CFU/cm2) are apparent from the table. One series of results is shown by the resulting Reduction (Log 10 CFU/cm2) that is apparent from the table. In the Examples, an increase in the value for the Reduction (Log 10 CFU/cm2) means an increase in the amount of pathogens or other bacteria that is reduced or eliminated from the sample due to treatment by the various solutions.

### EXAMPLE 3

Reduction of E. coli 0157:H7 on warm fat during transportation,
inoculation, holding, and treatment

| | Reduction |
|---|---|
| Treatment | (Log₁₀ CFU/cm²) |
| 24° C. Deionized water dip | 0.99 |
| 24° C. EO water dip | 1.30 |
| 62° C. EO water dip | 1.98 |
| 24° C. Deionized water spray | 1.31 |
| 24° C. EO water spray | 1.64 |
| 62° C. EO water spray | 3.79 |

The parameters for Example 3 are as follows. The initial population was 6.42 Log ₁₀CFU/cm². The acidic EO water utilized contained 81 mg/L chlorine. The dip treatment was conducted by immersing individual slices of meat fat tissue (6 inches diameter circular share) in 200 ml of treatment solution for 60 seconds with gentle hand shaking. The spray treatment was conducted by spraying treatment solution at 80 psi for 60 seconds with a distance of 8.5 cm. The total amount of treatment solution applied was 1300 ml. One series of results is shown by the resulting Reduction (Log 10 CFU/cm2) that is apparent from the table. In the Examples, an increase in the value for the Reduction (Log 10 CFU/cm2) means an increase in the amount of pathogens or other bacteria that is reduced or eliminated from the sample due to treatment by the various solutions.

TABLE 4
The Effect of Electrolyzed Oxidative Water Treatments on Beef Hides
Summary of results from day 1 EO Water Hide Wash

| | | | EBC | APC | |
|---|---|---|---|---|---|
| | | | (log10 | | Reduction |
| | | n | CFU/100 cm2) | | log10 CFU/cm2 |
| 90 ppm | control | 12 | 6.52 | 8.06 | |
| | NaOH (B) | 12 | 1.20 | 5.22 | EBC-5.32 |
| | | | | | APC-2.84 |
| | HOCl (A) | 12 | 1.44 | 4.31 | EBC-5.08 |
| | | | | | APC-3.75 |
| 60 ppm | control | 12 | 6.37 | 7.95 | |
| | NaOH (B) | 12 | 1.48 | 5.75 | EBC-4.89 |
| | | | | | APC-4.13 |
| | HOCl (A) | 12 | 2.24 | 5.03 | EBC-2.20 |
| | | | | | APC-2.92 |

control = sampled collected before treatments
NaOH = sampled collected after alkaline treatment
HOCl = sample collected after acidic treatment
APC = Aerobic Plate Count
EBC = Enterobacteriaceae Count

The parameters for Example 4 are as follows. The beef hides were collected from a beef processing plant and draped over barrels prior to testing. Each sample was taken from a different area of the same hide for accuracy. The area sampled was 500 cm² for controls, and 200 cm² post treatments. One series of results is shown by the resulting Reduction (Log 10 CFU/cm2) that is apparent from the table. In the Examples, an increase in the value for the Reduction (Log 10 CFU/cm2) means an increase in the amount of pathogens or other bacteria that is reduced or eliminated from the sample due to treatment by the various solutions.

Several different embodiments of the invention are discussed below. In each of the following embodiments of the invention, the ranges for pH, ORP, and ppm will be understood by those skilled in the art to be substitutable with any pH, ORP, or ppm within the ranges specified above in the more general discussion of Type A, Type B, and Type C solutions.

In a first embodiment of the method of the present invention, as applied to the meat product or meat carcass, the Type B solution was applied once in a shower, then the Type B solution was applied a second time in a spray cabinet, and finally the Type A solution was applied to the carcass in a spray cabinet. The application of a solution in a shower may possibly produce more pressure or larger volume of treatment to the product than application of a solution in a cabinet or sink. For example, an application of electrostatic spraying in a cabinet or sink may provide a finer mist than an application of spray from a shower. The cabinet spray application of a fine mist may provide an application of 10 ppm, while a shower spray that is more voluminous may provide an application 200 ppm.

A hot fluid wash using Type B solution was employed. Preferably, an alkaline Type B solution has a pH of 11.0, an ORP reading of 900⁻ mV and a beginning concentration of sodium hydroxide of 25 ppm. The solution is heated to a temperature greater than the fat temperature of the meat carcass before applying it to the meat carcass. Alkaline Type B solution was sprayed to meat from all angles at 35 psi and 7 gpm and a temperature of 50° C. using a spray nozzle. The solution was preferably sprayed for 1.5 seconds, but can be sprayed for a longer period. The spray washing using hot Type B solution saponifies the surface of meat immediately following de-hiding the hide from the meat carcass so that any fecal matter or other substance will not be adhered to the surface. No discoloration or deterioration occurred to the fat tissue evidenced by laboratory tests which showed no measurable changes to the consistency or texture of the target tissue upon exposure to hot Type B solution.

Within seconds after saponification at the de-hiding station, the meat was placed in two separate spray cabinets consecutively for further washing. Each of the two cabinets has spray tips with an opening. Electrolyzed Type B solution having a pH of 11.0 was sprayed to meat through the spray tips from all angles at 35 psi and a temperature of 50° C. This procedure further washes and saponifies the surface of meat for preparation of disinfecting step. The second application of Type B solution results in double the volume and dwell time.

Within seconds after the second application of Type B solution, the meat was removed from the Type B spray cabinet and placed in the Type A spray cabinet for disinfecting step. In this spray cabinet, the electrolyzed Type A solution is applied. The Type A solution has a pH of 2.5, an ORP reading of 1100⁺ mV and a beginning HOCl concentration of 25 ppm. The solution was heated to a temperature greater than the fat temperature of the meat carcass before applying it to the meat carcass. The solution was sprayed to meat from all angles at 35 psi and 7 gpm and a temperature of 50° C. using a spray nozzle. The solution was preferably sprayed for 1.5 seconds, but can be sprayed for a longer period. The spray tip had an opening, which sprayed the Type A solution. HOCl was diluted to 50 ppm after passing through the spray tips and ultimately landed on the carcass tissue. This disinfecting step kills harmful microbial agents on meat due to the antimicrobial capabilities of Type A solution.

After applying the Type A solution, the meat carcass is eviscerated, or cut open to remove all insides of the meat, such as intestines, gizzards, guts, and any other matter that is not rendered for ordinary consumption. After evisceration, all that remains is the muscle tissue of the meat carcass that is rendered for ordinary consumption by the public.

Immediately following evisceration, a spray of Type A solution may optionally be applied having a pH of 2.5, an ORP reading of 1150⁺ mV and a beginning HOCl concentration of 50 ppm. HOCl was diluted to 50 ppm after passing through the pressure spray nozzles and ultimately landed on the target tissue.

In a second embodiment of the method of the present invention, as applied to the meat product or meat carcass, after de-hiding the hide from the meat carcass, the Type B solution is applied by electrostatic spraying, and then the Type A solution is applied by dipping the meat carcass into Type A solution. The dipping process is conducted by placing the meat carcass in a chiller for a period of time and then removing it from the chiller and immediately dipping it into a solution of Type A solution. During the dipping process, in this embodiment as in other embodiments, it is helpful to agitate the solution somewhat. Agitation or shaking of the dipping solution was accomplished through an aeration device positioned underneath the carcass being treated.

The Type B solution has a pH of 9.0-9.5 and an ORP of 850⁻ mV, and a beginning concentration of sodium hydroxide of 8-10 ppm. The Type B solution was sprayed to the meat carcass for 17 seconds, and was followed by a 45 minute dwell period at 4° C. The Type A solution has a pH of 1.9-2.4, an ORP of 1150⁺ mV, and a beginning HOCl concentration of 8-10 ppm. The meat carcass was dipped into the Type A solution for 60 minutes at a temperature of 20° C. Optionally, after the meat carcass is dipped into the Type A solution, another application of Type B solution may be sprayed onto the carcass for further cleaning.

Alternatively, according to the method of Example 2, the Type B solution may be applied alone without applying Type A solution. Also, alternatively, the Type A solution may be applied alone without applying Type B solution.

The meat may be various temperatures. In the second embodiment, the meat was warm during transportation but reduced to room temperature during inoculation, holding, and treatment. In the third embodiment, the meat was warm during transportation, inoculation, holding, and treatment.

In a third embodiment of the method of the present invention, as applied to the meat product or meat carcass, after de-hiding the hide from the meat carcass, the Type A solution is applied by dipping the meat carcass into the Type A solution, without applying the Type B solution beforehand. The dipping process is conducted by placing the meat carcass in a chiller for a period of time and then removing it from the chiller and immediately dipping it into a solution of Type A solution. During the dipping process, in this embodiment as in other embodiments, it is helpful to agitate the solution somewhat. Agitation or shaking of the dipping solution was accomplished through an aeration device positioned underneath the carcass being treated.

The meat carcass was dipped into a Type A solution. The Type A solution has a pH of 2.5, an ORP reading of 1150⁺ mV, and a beginning HOCl concentration of 50 ppm. The temperature of the dip was about 2° C. The duration of each dip into the Type A solution was about 10 minutes.

In the fourth embodiment of the method of the present invention, as applied to the hide product, the Type B solution was applied once in a shower, then the Type B solution was applied a second time in a spray cabinet, and finally the Type A solution was applied to the hide in a spray cabinet.

A hot fluid wash using Type B solution was employed. Preferably, an alkaline Type B solution has a pH of 11.0, an ORP reading of 900⁻ mV and a beginning concentration of sodium hydroxide of 25 ppm. The solution is heated to a temperature greater than the temperature of the hide before applying it to the hide. Alkaline Type B solution was sprayed to hide from all angles at 35 psi and 7 gpm and a temperature of 50° C. using a spray nozzle. The solution was preferably sprayed for 1.5 seconds, but can be sprayed for a longer period. The spray washing using hot Type B solution saponifies the surface of hide immediately following de-hiding the hide from the carcass so that any fecal matter or other substance will not be adhered to the hide surface.

Within seconds after saponification at the de-hiding station, the hide was placed in two separate spray cabinets consecutively for further washing. Each of the two cabinets has spray tips with an opening. Electrolyzed Type B solution having a pH of 11.0 was sprayed to hide through the spray tips from all angles at 35 psi and a temperature of 50° C. This procedure further washes and saponifies the surface of hide for preparation of disinfecting step. The second application of Type B solution results in double the volume and dwell time.

Within seconds after the second application of Type B solution, the hide was removed from the Type B spray cabinet and placed in the Type A spray cabinet for disinfecting step. In this spray cabinet, the electrolyzed Type A solution is applied. The Type A solution has a pH of 2.5, an ORP reading of 1100⁺ mV and a beginning HOCl concentration of 25 ppm. The solution was heated to a temperature greater than the temperature of the hide before applying it to the hide. The solution was sprayed to hide from all angles at 35 psi and 7 gpm and a temperature of 50° C. using a spray nozzle. The solution was preferably sprayed for 1.5 seconds, but can be sprayed for a longer period. The spray tip had an opening, which sprayed the Type A solution. HOCl was diluted to 50 ppm after passing through the spray tips and ultimately landed on the carcass tissue. This disinfecting step kills harmful microbial agents on hide due to the antimicrobial capabilities of Type A solution.

In the fifth embodiment of the method of the present invention, as applied to the hide product, after de-hiding the hide from the carcass, the Type B solution is applied by electrostatic spraying, and then the Type A solution is applied by dipping the hide into Type A solution. The dipping process is conducted by placing the hide in a chiller for a period of time and then removing it from the chiller and immediately dipping it into a solution of Type A solution. During the dipping process, in this embodiment as in other embodiments, it is helpful to agitate the solution somewhat. Agitation or shaking of the dipping solution was accomplished through an aeration device positioned underneath the carcass being treated.

The Type B solution has a pH of 9.0-9.5 and an ORP of 850⁻ mV, and a beginning concentration of sodium hydroxide of 8-10 ppm. The Type B solution was sprayed to the hide for 17 seconds, and was followed by a 45 minute dwell period at 4° C. The Type A solution has a pH of 1.9-2.4, an ORP of 1150⁺ mV, and a beginning HOCl concentration of 8-10 ppm. The hide was dipped into the Type A solution for 60 minutes at a temperature of 20° C. Optionally, after the hide is dipped into the Type A solution, another application of Type B solution may be sprayed onto the hide for further cleaning.

Alternatively, according to the method of Example 2, the Type B solution may be applied alone without applying Type A solution. Also, alternatively, the Type A solution may be applied alone without applying Type B solution.

In the sixth embodiment of the method of the present invention, as applied to the hide product, after de-hiding the hide from the carcass, the Type A solution is applied by dipping the hide into the Type A solution, without applying the Type B solution beforehand. The dipping process is conducted by placing the hide in a chiller for a period of time and then removing it from the chiller and immediately dipping it into a solution of Type A solution. During the dipping process, in this embodiment as in other embodiments, it is helpful to agitate the solution somewhat. Agitation or shaking of the dipping solution was accomplished through an aeration device positioned underneath the carcass being treated.

The hide was dipped into a Type A solution. The Type A solution has a pH of 2.5, an ORP reading of 1150⁺ mV, and a beginning HOCl concentration of 50 ppm. The temperature of the dip was about 2° C. The duration of each dip into the Type A solution was about 10 minutes.

The Type C solution was not tested in the examples, but persons of ordinary skill in the art will understand that Type C solution has substantially the same effect as Type A solution. Although Type C solution has a less acidic pH than Type A solution, Type C solution is a stabilized form of Type A solution and has a longer shelf-life than Type A solution. As such, in the following examples and embodiments, it should be understood that application of the Type C solution herein described may substitute or replace the application of the Type A solution in any of the methods of the present invention.

Additional alternative embodiments of the methods of the present invention may feature any combination of Type A, Type B, and Type C solutions in any series of steps. For example, one embodiment may apply Type B solution, then Type A solution, and then finally Type C solution after applying the Type B and Type A solutions. The result of any such combinations or series of steps will result in the cleaning and disinfecting of the face and hands while preventing cytotoxicity and skin irritation.

The present invention for cleaning and disinfecting a meat product, and/or a hide product, has important advantages. One of the unique features of creating electrolyzed oxidative water is that it is produced on site without adding any toxic chemicals, and is environmentally friendly. Only lab grade salt is added to the initial process as an electrolyte to assist in the electrolysis process. During the electrolysis process, small amount of chlorine easily gases off from the holding tank and quickly dissipates into open atmosphere. The fluid is created in a room where the venting can be accomplished without risk to the operators, the workers or the environment.

In tests conducted at a major university and at an operating plant the electrolyzed solutions are capable of achieving as high as a 6 log (99.9999 per cent) reduction in salmonella and E. coli on carcasses. The electrolyzed water is highly efficacious, achieving higher kill rates of harmful pathogens than alternative cleaners and disinfectants. It is capable of killing bacteria, viruses, spores, and molds within seconds of contact. The high oxidative reduction potential of the water solution first damages the cell walls, thus allowing infiltration of the water solution inside the cell walls. The microbe reaches capacity causing an osmotic or hydration overload. The acidic fluid floods the cell faster than the cell can expel the fluid, thereby causing the cell to burst. The electrolyzed water provides additional advantages over standard chemical and pharmaceutical cleaners and disinfectants, because such standard toxic chemicals create resistant strains of pathogens that become resistant over time, eventually limiting their overall efficacy.

Products treated with the EO fluids need not be artificially inoculated or contaminated with additional pathogens for test purposes. Whatever the count is on the animal at the time of processing from the actual kill floor to the de-hiding area will be measured following the current and standard operating procedures now employed by the plant. Measurement procedures are applied to the target carcasses in the same manner as the control and under actual live plant conditions.

All necessary equipment and spray cabinets will be installed with no disruption of normal day-to-day process or inspection. The electrolyzed fluids will be created in a separate holding room and piped to testing areas and plumbed into existing feed lines and applied with the installed spray cabinets.

Although some embodiments of the present invention have been described in detail, it should be understood that various changes, substitutions, and alterations can be made hereupon without departing from the principle and scope of the invention. Accordingly, the scope of the present invention should be determined by the following claims and their appropriate legal equivalents.

1. A method for cleaning and disinfecting, comprising:
(a) providing a food product, a first non-toxic solution including an electrolyzed alkaline solution; and a second non-toxic solution including an electrolyzed acidic solution;
(b) cleaning the food product by saponifying the first solution to a surface of the food product; and then
(c) disinfecting the food product by applying the second solution to the surface of the food product.

2. The method of claim 1, further comprising providing a third non-toxic solution including an electrolyzed stabilized acidic solution, and applying the third solution to the surface of the food product after steps (b) and (c).

3. The method of claim 1, wherein steps (b)-(c) comprise applying the solutions to the food product immediately after removing a hide from the food product, and at the location where the hide is removed from the food product.

4. The method of claim 1, wherein the second solution has a pH in the range of about 1.8 to about 2.4, an ORP in the range of about +1000 mV to about +1170 mV, and a hypochloric acid concentration in the range of about 10 ppm to about 200 ppm.

5. The method of claim 1, wherein the first solution has a pH in the range of about 10.5 to about 12.0, an ORP in the range of about −800 mV to about −1000 mV, and a concentration of sodium hydroxide in the range of about 10 ppm to about 200 ppm.

6. The method of claim 2, wherein the third solution has a pH in the range of about 2.5 to about 6.0, an ORP in the range of about +850 mV to about +1150 mV, and a hypochloric acid concentration in the range of about 10 ppm to about 200 ppm.

7. The method of claim 1, wherein step (b) comprises spraying the first solution from a spray device at a selected pressure for a selected amount of time onto the food product, and wherein step (c) comprises spraying the second solution from a spray device at a selected pressure for a selected amount of time onto the food product.

8. The method of claim 1, wherein step (b) comprises dipping the food product for a selected amount of time into the first solution, and wherein step (c) comprises dipping the food product for a selected amount of time into the second solution.

9. The method of claim 1, wherein step (b) comprises heating the first solution before applying the first solution to the food product, and wherein step (c) comprises heating the second solution before applying the second solution to the food product.

10. The method of claim 1, wherein the second and first solutions are heated to a temperature greater than the fat temperature of a food carcass of the food product.

11. A method for cleaning and disinfecting, comprising:
(a) removing a hide from a carcass of an animal;
(b) cleaning the hide by saponifying the hide with a first non-toxic solution including an electrolyzed alkaline solution; and then
(c) disinfecting the hide by applying to the hide a second non-toxic solution containing an electrolyzed acidic solution.

12. The method of claim 11, further comprising providing a third non-toxic solution including an electrolyzed stabilized acidic solution, and applying the third solution to the surface of the hide after steps (b) and (c).

13. The method of claim 14, wherein steps (b)-(c) comprise applying the solutions to the hide immediately after removing the hide from the carcass, and applying the solutions at the location where the hide is removed from the carcass.

14. The method of claim 14, wherein the second solution has a pH in the range of about 1.8 to about 2.4, an ORP in the range of about +1000 mV to about +1170 mV, and a hypochloric acid concentration in the range of about 10 ppm to about 200 ppm.

15. The method of claim 14, wherein the first solution has a pH in the range of about 10.5 to about 12.0, an ORP in the range of about −800 mV to about −1000 mV, and a concentration of sodium hydroxide in the range of about 10 ppm to about 200 ppm.

16. The method of claim 12, wherein the third solution has a pH in the range of about 2.5 to about 6.0, an ORP in the range of about +850 mV to about +1150 mV, and a hypochloric acid concentration in the range of about 10 ppm to about 200 ppm.

17. The method of claim 14, wherein step (b) comprises spraying the first solution from a spray device at a selected pressure for a selected amount of time onto the hide, and wherein step (c) comprises spraying the second solution from a spray device at a selected pressure for a selected amount of time onto the hide.

18. The method of claim 14, wherein step (b) comprises dipping the hide for a selected amount of time into the first solution, and wherein step (c) comprises dipping the hide for a selected amount of time into the second solution.

19. The method of claim 14, wherein step (b) comprises heating the first solution before applying the first solution to the hide, and wherein step (c) comprises heating the second solution before applying the second solution to the hide.

20. The method of claim 14, wherein the solutions are heated to a temperature greater than the hide when removed from a food carcass.
